(19) United States
(12) Patent Application Publication
(10) Pub. No.: US 2021/0234877 A1
(43) Pub. Date: Jul. 29, 2021

(54) PROACTIVELY PROTECTING SERVICE ENDPOINTS BASED ON DEEP LEARNING OF USER LOCATION AND ACCESS PATTERNS

(71) Applicant: Hewlett Packard Enterprise Development LP, Houston, TX (US)

(72) Inventors: Murthy Prabhu, Bangalore Karnataka (IN); Jyoti Ranjan, Bangalore Karnataka (IN); Anusha Chaparala, Bangalore Karnataka (IN)

(21) Appl. No.: 16/775,665

(22) Filed: Jan. 29, 2020

(51) Int. Cl. H04L 29/06; G06N 20/00; G06K 9/62

(52) U.S. Cl. CPC H04L 63/1425; H04L 63/107; H04L 63/102; H04L 2463/082; G06N 20/00; G06K 9/6255; H04L 63/105

(57) ABSTRACT

Example implementations relate to proactively protecting service endpoints based on deep learning of user location and access patterns. A machine-learning model is trained to recognize anomalies in access patterns relating to endpoints of a cloud-based service by capturing metadata associated with user accesses. The metadata for a given access includes information regarding a particular user that initiated the given access, a particular device utilized, a particular location associated with the given access and specific workloads associated with the given access. An anomaly relating to an access by a user to a service endpoint is identified by monitoring the access patterns and applying the machine-learning model to metadata associated with the access. Based on a degree of risk to the cloud-based service associated with the identified anomaly, a mitigation action is determined. The cloud-based service is proactively protected by programmatically applying the determined mitigation action.

### BACKGROUND

The cloud is becoming ubiquitous as a result of the maturity, robustness, flexibility and simplicity of cloud computing architectures. The cloud's service-oriented delivery model of offering anything as a service (XaaS) has fueled its popularity because of its ability to serve a service endpoint (whether it be within a private data center, a public data center or associated with a cloud management platform) from anywhere. Platform as a Service (PaaS), Software as a Service (SaaS), Container as a Service (CaaS), Infrastructure as a Service (IaaS) are a few non-limiting examples of the various delivery models.

Cloud services generally provide an application programming interface (API) (e.g., a set of representational state transfer (REST) endpoints) that are called upon by a user to perform a specific operations. For example, in the context of IaaS, a service might have endpoints to create a virtual machine (VM), to attach a storage volume to a VM, to get a list of VMs, and to delete VMs, etc.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram conceptually illustrating various components of a system in accordance with an embodiment.

FIG. 2 is a high-level flow diagram illustrating endpoint protection processing in accordance with an embodiment.

FIG. 3 is a flow diagram illustrating endpoint protection system deployment processing in accordance with an embodiment.

FIG. 4 is a flow diagram illustrating user access pattern processing in accordance with an embodiment.

FIG. 5 is a flow diagram illustrating anomaly detection processing in accordance with an embodiment.

FIG. 6 is a flow diagram illustrating anomaly mitigation processing in accordance with an embodiment.

FIG. 7 is a block diagram of a computer system in accordance with an embodiment.

### DETAILED DESCRIPTION

Embodiments described herein are generally directed to proactively protecting service endpoints based on deep learning of user location and access patterns. In the following description, numerous specific details are set forth in order to provide a thorough understanding of example embodiments. It will be apparent, however, to one skilled in the art that embodiments described herein may be practiced without some of these specific details. In other instances, well-known structures and devices are shown in block diagram form.

Service endpoints represent vulnerable points of entry for cyberattacks. With organizational workforces becoming more mobile and users connecting to internal resources from off-premise devices all over the world, service endpoints are increasingly susceptible to cyberattacks. Any endpoint represents a gateway into an Information Technology (IT) system, which might leak sensitive information if it gets hacked, compromised or is otherwise subjected to a hostile environment. For example, a cybercriminal, hacker or attacker can use invalid input to a service endpoint with an intent to cause a failure in an attempt to peep into the API response, logs, and/or the call stack to obtain information about the service and the components used by the service. The attacker can then use information leaked via the service endpoint to facilitate an attack on the host system.

The susceptibility of service endpoints to attack is largely a result of traditional security mechanisms relying on the Hypertext Transfer Protocol Secure (HTTPS) and authentication systems for detecting and responding to known threats after they have already entered a network. While good defense mechanisms exist, they are typically reactive in nature and do not protect against malicious use of legitimate credentials (e.g., a user name and password or token). For example, a hacker may steal user credentials or add him/herself as a user to the system at issue via a free subscription, for example. Furthermore, experienced attackers have found other ways to bypass service authentication/access mechanisms with inexpensive, automated online tools that produce countless unique, unknown attacks. As a result, an attacker can access a service endpoint (e.g., a REST API) from location X pretending to be a legitimate user accessing the service endpoint from location Y. As such, in order to prevent security breaches, organizations should protect service endpoints as a second line of defense in the event that user credentials are compromised.

Embodiments described herein seek to leverage spatial coherence, client device affinity and service endpoint access patterns to provide proactive endpoint protection by detecting anomalies in relation to who is accessing the endpoint from where and how.

According to one embodiment, a proactive model of protecting a service endpoint is provided even if a user's credentials are compromised. In various embodiments described herein an endpoint protection system leverages deep learning regarding user access patterns relating to a service endpoint in terms of (i) a location from which the endpoint is being accessed; (ii) the user associated with the access; (iii) a client device that is being used to access the endpoint; (iv) the workload pattern for which the service endpoint is being used; and (v) a degree to which the user's service endpoint access pattern is violating a pre-defined access policy.

In some embodiments, an observation component of an endpoint protection system may be deployed for all public endpoints of a cloud-based service. Based on information captured by the observation component, the endpoint protection system may leverage information like user credentials, the users' location and the users' access pattern along with a pre-defined access pattern for set of users. In one embodiment, the endpoint protection system analyzes service endpoint accesses against common patterns learned by an analytic engine to identify potential security breaches. When a potential anomaly in access patterns is detected a variety of mitigation techniques can be automatically applied, including multi-factor authentication and authorization techniques, generation of alerts, and/or temporary or permanent denial of access to the service. In this manner, a proactive approach is provided that detects potential security breaches before the attacker is able to more deeply compromise the system, infiltrate sensitive information or cause a Denial of Service (DoS) situation.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, the term “anomaly” generally refers to an observation that does not confirm to the expected normal behavior. The data representing historical behavior patterns may be represented in a collection of records, each of which is described by a set of attributes (or features). Broadly speaking, anomalies might be either individual anomalies (corresponding to a single record) or collective anomalies (corresponding to groups of records). For example, in credit card fraud detection, it is desirable to monitor each transaction to determine if it conforms to the usual behavior of the customer. In such a case, an anomaly detection method is employed that tests each record individually and searches for single record anomalies. Similarly, in the present context relating to endpoint usage and/or access patterns, an individual anomaly detection approach may be used. According to one embodiment, the approach for performing individual anomaly detection involves creation or training of a model based on normal data and then comparing test records against it. For example, a probabilistic approach can be used that builds a likelihood model from the training data. Records (e.g., data associated with real-time observations relating to endpoint usage and/or access patterns) can then be tested for anomalies based on the complete record likelihood given the probability model. One challenge in anomaly detection is the difficulty to obtain sufficient labeled data to characterize anomalies. Hence, in one embodiment, it is desirable to operate the system in an unsupervised setting, where only normal behavior is characterized during a training phase, and is subsequently used during an inference phase to detect deviations from it. Along with this, it is desirable to also have an anomalousness measure or score to compare new observations to the usual state. Given this scoring method, any observation that significantly deviates from the usual may be flagged as an anomaly.

As used herein “spatial coherence” generally refers to a measure of the correlation between accesses made by a user to a service endpoint measured at different geographical locations. For example, a typical user of a cloud-based service is likely to access the service from between approximately one to five locations (e.g., home, office, coffee shop) or within a given range of a geo-circle of tens of miles.

As used herein the phrase “client device affinity” generally refers to the relationship between a particular user and a particular client device. While it is a fact that a variety of client devices can be used by the same user, a given user is likely to access a service endpoint with a constant set of devices (e.g., mobile, laptop, desktop) or a constant set of applications (e.g., Internet Explorer, Safari, Chrome or Postman). According to one embodiment, code associated with the client device can be instrumented to provide the server side with details about the client device and/or the application through which the endpoints are being exercised. For example, in one embodiment, the User-Agent string within an HTTP request may be configured to include information regarding details of the client device (e.g., (i) the type of device, such as iPhone, iPad, MacBook, Mac Pro, (ii) the operating system, and (iii) the client software (e.g., web browser) and version.

As used herein the phrase “service endpoint access pattern” or “endpoint access pattern” generally refers a pattern relating to the way in which a particular user accesses a service endpoint and/or the set of workloads resulting from such accesses. While it is a fact that different users of a service will have different patterns of service endpoint accesses, it is not so diverse for a given user. For example, a given user is likely to access the service endpoint in a specific way with a specific set of workloads most of the time. So, a service endpoint access pattern can be revealed or deduced by performing deep learning on user access patterns.

### Overview

In accordance with embodiments, metadata or derived information associated with multiple participants associated with service endpoint accesses are used to detect potential security threats. For example, information regarding a current access to a service endpoint may be analysed with reference to a probabilistic model created based on historical information regarding one or more of the user, the service endpoint and the IP address of the client device used by the user to access the service endpoint to identify an anomaly. Non-limiting examples of metadata include information extracted from the User-Agent string of an HTTP request, the username, and the time and/or date of the access. A non-limiting example of derived information includes a geographical location or region as determined based on performing an Internet Protocol (IP) address geolocation lookup on the IP address of the client device being employed by the user.

When the user and client IP addresses are analysed, homogeneity can be identified in accesses patterns despite of the surface level heterogeneity resulting from different users, different client IP addresses, and different devices being used to access the service endpoint. For example, one aspect of the homogeneity is in the pattern of IP addresses that a user uses to access the service endpoint most of time. For a given user, it is more or less the same set of IP addresses. For example, a first user may typically access a service to manage cloud infrastructure from home or from the office using his/her laptop, a second user may be involved in creating or deploying an application from his laptop using a specific API of the service, and a third user may be provision a cluster from his/her laptop using the Kubernetes lifecycle manager endpoint. So, despite the apparent heterogeneity of data observed/collected regarding user accesses to service endpoints, there are some static or semi-static patterns hidden underneath the heterogeneity that can be used in accordance with various embodiments described herein to safeguard service endpoints.

In accordance with various embodiments, historical information regarding a client device and its location (e.g., based on the IP address of the client, even if it is behind a proxy, the proxy IP address can be used as the client IP address) and a service endpoint access pattern are used to detect anomalies in who is accessing the service endpoint what from where and how.

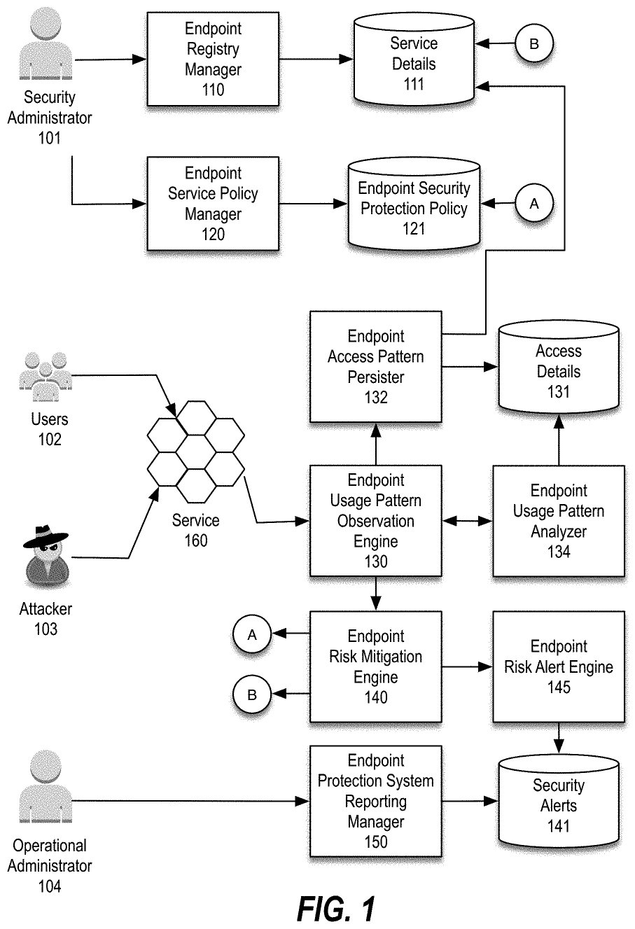

FIG. 1 is a block diagram conceptually illustrating various components of a system in accordance with an embodiment. In the context of the present example a system for proactively protecting service endpoints of a service 160 based on deep learning of user location and access patterns includes an endpoint registry manager 110, an endpoint service policy manager 120, an endpoint usage pattern observation engine 130, an endpoint access pattern persister 132, an endpoint usage pattern analyzer 134, an endpoint risk mitigation engine 140, an endpoint risk alerting engine 145, and an endpoint protection system reporting manager 150. Depending upon the particular implementation, the system can be deployed as add-on service or may be integrated with the service 160.

According to one embodiment, the endpoint registry manager 110 is used by a security administrator 101 to register a set of applications that are to be observed for potential endpoint risks. Empirical data suggests that a system of average complexity is likely to have between approximately 40-60 micro-services. Not all micro-services need to be protected, however, as some may be for internal functionality and therefore will not have a published interface available to end users. In an embodiment, the endpoint registry manager 110 module assists the security administrator 101 in connection with deciding which endpoints needs to be subjected to proactive detection of potential security breaches. In the context of the present example, the security administrator 101 registers service 160 and one or more endpoints that are to be protected with the endpoint registry manager 110 and the endpoint registry manager 110 persists information regarding the service 160 and the one or more endpoints of the service 160 within a service details 111 datastore.

The endpoint security policy manger 120 may assist the security administrator 101 in defining how the overall endpoint protection system will function. In one embodiment, the endpoint security policy manager 120 may facilitate definition of endpoint protection policies by receiving two types of data from the security administrator 101—one type to define service endpoint access violations and another to define mitigation steps to address violations and/or potential security threats detected by endpoint usage pattern analyzer 134. For example, the security administrator 101 may define an expected access pattern for a service endpoint. Since location and client device patterns are learned for users over time in accordance with their actual usage of the service, according to one embodiment, the predefined service endpoint policies need not be defined in terms of location or client device, but rather can be defined in terms of other factors (e.g., frequency of endpoint access, order of access, and the like, for a give user or group of users). According to one embodiment, if the actual user access pattern differs from the expected access pattern (e.g., the predefined service endpoint policy), this can be considered a violation. In embodiments, access patterns can be defined on a per user basis or for a group of users and persisted to the endpoint security protection policy datastore 121. In addition, as discussed further below, a default endpoint protection policy may be used in connection with anomalous patterns observed by the system that have not been mapped by the security administrator 101 to a particular predefined service endpoint policy. Further still, in some embodiments, the security administrator 101 may be permitted to whitelist certain patterns so as to prevent them from being treated as anomalies. For example, if a user will be traveling to a foreign country, the security administrator 101 may preemptively preclude anomaly triggering relating to location anomalies for the particular foreign country for that user by temporarily adding a whitelist policy for that user. Alternatively, in some embodiments, the expected access patterns can be used to accomplish this type of whitelisting.

With respect to mitigation steps, in various embodiments described herein, the security administrator 101 is provided with the flexibility to define potential risk patterns and associated automated mitigation plans. For example, the security administrator 101 may define appropriate mitigation steps to be applied responsive to violations of the predefined service endpoint policies or responsive to detected potential security threats. In this manner, not all potential security risks are treated with the same degree of intensity. Such flexibility also allows the security administrator 101 to avoid frequent generation of spurious alerts.

According to one embodiment, multiple types of mitigation actions or steps and/or sets thereof that have been pre-defined or configured by the system administrator 101 can be programmatically performed by the endpoint risk mitigation engine 140 at the direction of the endpoint usage pattern observation engine 130. For example, multiple types of mitigation actions or steps may be mapped by the security administrator 101 to events or access scenarios associated with various levels of severity of security risk (e.g., low, medium and high) to facilitate automatic application of appropriate mitigation actions by the endpoint risk mitigation engine 140. Non-limiting examples of mitigation actions include logging an alert, notifying appropriate security personnel (e.g., the security administrator), increasing the burden on the user in relation to authentication, enabling the use of multi-factor authentication, temporarily denying service endpoint access to the user, and denying service endpoint access completely (e.g., until overridden by the security administrator 101).

Endpoint access anomalies associated with a low security risk can be associated with relatively less burdensome mitigation actions. For example, if the location from which a client device is accessing a service endpoint has changed and does not correspond to a location associated with the user's historical access pattern, then the security administrator 101 may require the system to increase the degree of certainty that the user is who he/she says he/she is by, for example, (i) prompting the user to answer one or more security questions and/or (ii) enabling multi-factor authentication (e.g., via short message service (SMS) verification or via an authentication app, such as Google Authenticator, LastPass Authenticator, Microsoft Authenticator, Authy, Yubico Authenticator, or the like). As another example, if a particular client location is used to exercise the service endpoint with an invalid payload more than X times in a row, the security administrator 101 may configure the mitigation steps to include asking the user more security questions. As yet another example, if the client device (e.g., mobile, laptop, desktop) or its type (e.g., as indicated by the user-agent string) has changed, the security administrator 101 may configure the mitigation steps to include asking the user more security question or prompting the user to re-generate a new token.

Endpoint access anomalies associated with a medium security risk can be met with mitigation actions of higher intensity. For example, if it appears an attack is being employed to obtain sensitive information (e.g., by subjecting the endpoint to error scenarios and observing the API response, failed call trace, log or the like), then the system administrator 101 may configure the mitigation steps to include denying service endpoint access for the user for a predetermined or configurable amount of time (e.g., 30 minutes). As another example, If client has used an invalid token Y times in a row then, then the user can be denied access to the particular endpoint or all protected endpoints of the service a predetermined or configurable amount of time.

Endpoint access anomalies associated with a high security risk can be met with the highest intensity of mitigation actions. According to one embodiment, access to the service endpoint at issue or all protected service endpoints can be denied completely (subject to reset by the system administrator 101) if the exercised workload pattern appears to be hostile and might lead to a DoS attack. For example, if the client is trying to access an internal database that the service might have leaked, then access to the service may be disabled for the user. Similarly, if as a result of a user exercising a service endpoint there is a sudden increase in the workload and at such a rate that it may impact the ability of other users to access the service, then access to the service may be disabled for the user.

Turning now to the endpoint access pattern persister 132, according to one embodiment, it persists the user endpoint access pattern. The endpoint access pattern persister 132 may record various metadata and/or derived information associated with service endpoint accesses. For example, the endpoint access pattern persister 132 may store information within the access details datastore 131 regarding the user (e.g., the user account) associated with the service endpoint access, the user location (e.g., a geographical location or region as determined based on performing an IP geolocation lookup on the IP address of the client device being employed by the user), the client device, and the service endpoint access pattern (e.g., the workloads performed, the resources accessed, the time of day, the date, etc.). According to one embodiment, after a certain seeding period, the data collected over time regarding the user endpoint access pattern may be used to train a machine-learning model or otherwise analyzed by machine-learning tools to understand the access pattern of the user. As described in further detail below, in various embodiments, the discovered or learned pattern of a given user may be later used to detect endpoint access anomalies by the endpoint usage pattern analyzer 134.

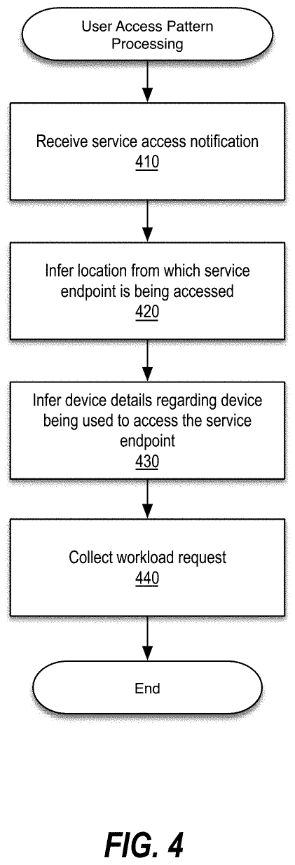

In the context of the present example, the endpoint usage pattern observation engine 130 orchestrates with other components of system to achieve the desired goal of proactive endpoint protection. According to one embodiment, the endpoint usage pattern observation engine 130 (i) observes service endpoint access patterns from users 102 and from potential attackers (e.g., attacker 103); (ii) persists the access patterns, including information regarding the user, user location, user device and user workload pattern, via the endpoint access pattern persister 132; (iii) checks if there is an anomaly associated with the endpoint access pattern that may represent a potential security risk (e.g., a risk to functionality of the service 160) by, for example, sending a request to the endpoint usage pattern analyzer 134; and (iv) responsive to identification of a potential risk causing appropriate mitigation actions to be performed by, for example, sending a mitigation request to the endpoint risk mitigation engine 140. Otherwise, if no anomaly is identified for a particular user access to the service endpoint at issue, then the user request is handled via the normal path with the service 160. An example of user pattern processing that may be performed by endpoint usage pattern observation 130 is described further below with reference to FIG. 4.

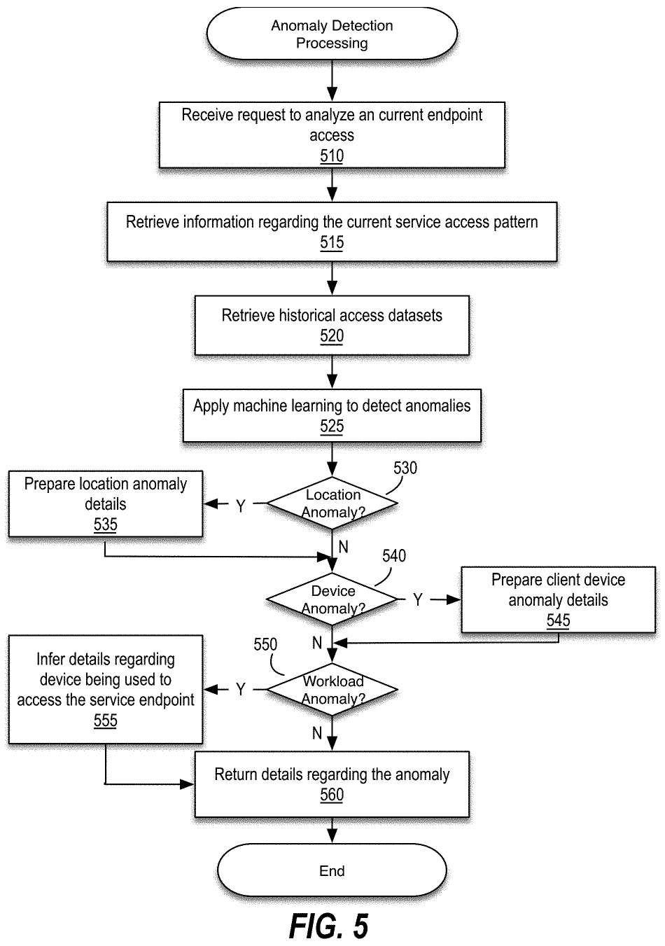

In the context of the present example, responsive to a request received from the endpoint usage pattern observation engine 130, the endpoint usage pattern analyzer 134 performs anomaly detection processing. For example, the endpoint usage pattern analyzer 134 may analyze historical data to identify a change in user location, user client device and/or the user's access pattern. According to one embodiment, the endpoint usage pattern analyzer 134 makes use of a deep learning algorithm to understand various patterns in a manner similar to the way social media applications understand user access patterns. Those skilled in the art will appreciate a variety of deep learning algorithms may be used to detect patterns from historical datasets and identify anomalies. According to one embodiment, any Artificial Neural Network (ANN)-based deep learning algorithm that has been trained to detect a variance in pattern may be employed. For example, in a likelihood based approach in which “normal” data is modeled as a probability distribution, dependency trees and/or Bayesian networks may be used to represent the probability density model. An example of anomaly detection processing that may be performed by endpoint usage pattern analyzer 134 is described further below with reference to FIG. 5.

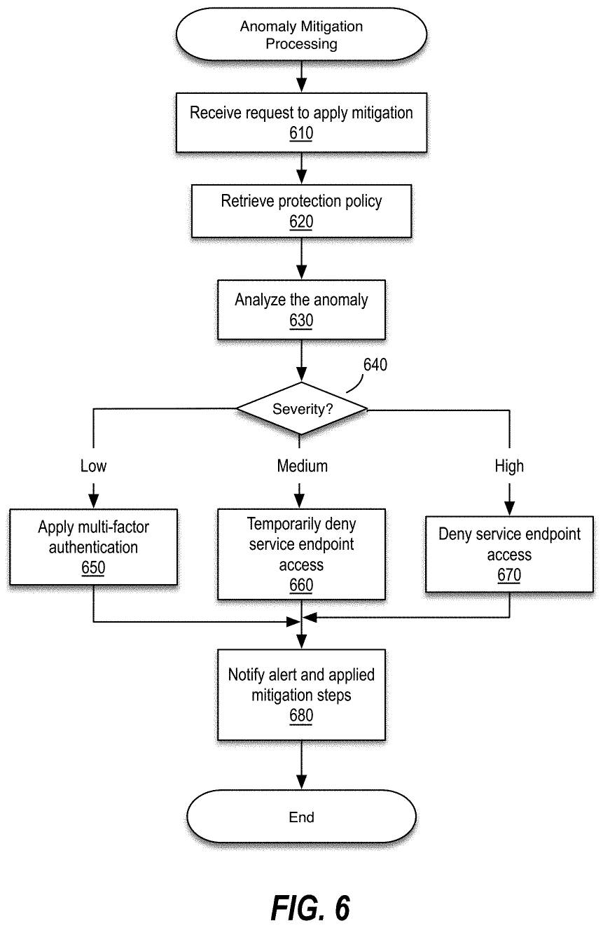

According to one embodiment, the endpoint risk mitigation engine 140 programmatically applies one or more mitigation steps to proactively protect the service endpoint from potential cyberattacks. In an example, the endpoint risk mitigation engine 140 leverages endpoint protection policies defined by the security administrator 101 using the endpoint security policy manager 120. In some embodiment, when a new anomalous pattern is identified that has not been defined by the security administrator 101, then the endpoint risk mitigation engine 140 applies a default endpoint protection policy. In the context of the present example, after applying the appropriate mitigation steps based on an endpoint security protection policy retrieved from the endpoint security protection policy datastore 121, the endpoint risk mitigation engine 140 notifies the endpoint risk alert engine 145 regarding the potential risk and applied mitigation steps so that appropriate personnel (e.g., the security administrator 101) may be notified through appropriate channels (e.g., email, SMS, alerts, etc.). Additionally, the endpoint risk engine 145 may persist data regarding the identified security threat, the associated mitigation steps performed and the date and time the potential security threat was observed to the security alerts datastore 141. An example of anomaly mitigation processing that may be performed by endpoint risk mitigation engine 140 is described further below with reference to FIG. 6.

Moving on to the endpoint protection system reporting manager 150, it may be used by the operational administrator 104 to filter, sort and/or otherwise search the security alerts datastore 141 to extract desired information regarding security threats generated over a period of time along with applied steps to mitigate them. According to one embodiment, the security alerts datastore 141 includes a set of records having fields including information regarding the user, the user access details (e.g., location, device and service operation), the normal access pattern by the user in recent time, the anomaly in the access pattern leading to the alert regarding the potential security risk, and mitigation steps applied responsive to detection of the potential threat.

While in the context of the present example, the security administrator 101 and the operational administrator 104 are shown as being two different users, those skilled in the art will appreciate that they may be one and the same. Similarly, while the users 102 are shown separately from the security administrator 101 and operational administrator 104, the security administrator 101 and/or the operational administrator may be one of the users 102.

In one embodiment, the various datastores described herein may be in-memory data structures, files, databases or database tables. For example, the service details datastore 111, the endpoint security protection policy datastore 121, the access details datastore 131, and the security alerts datastore 141 may each represent a database table within a relational database (not shown). Alternatively, these various datastores may represent individual disk files. Those skilled in the art appreciate the datastores described herein may be subdivided into smaller collections of a greater number of datastores of related data or aggregated into larger collections of a lesser number of datastores of related data.

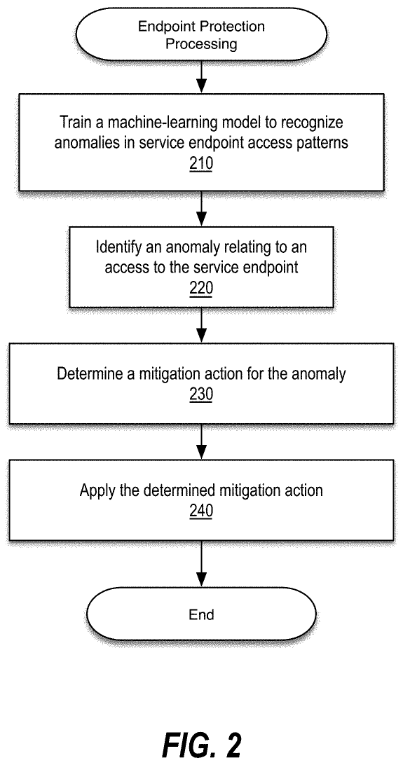

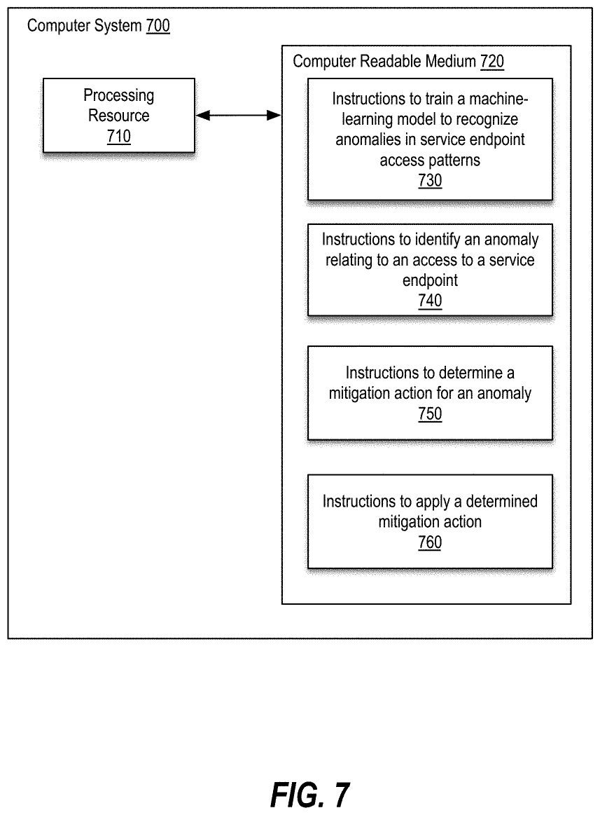

The processing described below with reference to the flow diagrams of FIGS. 2-6 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, processing may be performed by one or more virtual or physical computer systems of various forms, such as the computer system described with reference to FIG. 7 below.

FIG. 2 is a high-level flow diagram illustrating endpoint protection processing in accordance with an embodiment. At block 210, a machine-learning model is trained to recognize anomalies in service endpoint access patterns. According to one embodiment, a probability model is created based on “normal” training data. For example, the endpoint protection system may observe service endpoint access patterns during a supervised or unsupervised training phase and use dependency trees and/or Bayesian networks to represent the probability density model.

At block 220, an anomaly is identified relating to a real-time access to the service endpoint. According to one embodiment, calls to a service endpoint are hooked or otherwise redirected to monitoring and analysis processing. For example, before taking action on the user request, the service endpoint may be configured to pass information regarding the access to an endpoint usage pattern observation engine (e.g., endpoint usage pattern observation engine 130)

According to one embodiment, each time a service endpoint is accessed metadata and/or derived information associated with the service endpoint call is captured and persisted. For example, as noted above, the endpoint access pattern persister 132 may store information within the access details datastore 131 regarding the user making the service endpoint access, the user location, the client device, and the service endpoint access pattern.

In addition to persisting the information regarding the service endpoint call, in real-time, anomaly detection processing may be performed by analyzing the information regarding the service endpoint call with reference to the machine-learning model. For example, an endpoint usage pattern analyzer (e.g., endpoint usage pattern analyzer 134) compare the information regarding the service endpoint call at issue to the probability density model created in block 210 to identify an anomaly (e.g., a change in user location, user client device and/or the user's access pattern that deviates from established patterns by a predefined or configurable anomalousness threshold). In an embodiment in which the security administrator is provided with the ability to define expected access patterns, violation of such an access pattern may also be considered an anomaly.

At block 230, a set of mitigation actions are determined for the identified anomaly. According to one embodiment, a security administrator (e.g., security administrator 101) has previously defined potential risk patterns and associated automated mitigation plans. In such an embodiment, determining the set of mitigation actions may represent retrieving a mitigation action that has been mapped to the security risk of the identified anomaly. For example, a risk mitigation engine (e.g., risk mitigation engine 140) may retrieve an endpoint protection policy from an endpoint security protection policy datastore (e.g., endpoint security protection policy datastore 121) that directly or indirectly specifies the set of mitigation actions. In one embodiment, the endpoint protection policy indicates a degree of security risk (e.g., low, medium, or high) for the identified anomaly that can be used to lookup the appropriate set of mitigation actions. Alternatively, the retrieved endpoint security protection policy may contain information specifying the set of mitigation actions.

At block 240, the determined set of mitigation actions are applied. According to one embodiment, the endpoint risk mitigation engine 140 automatically and programmatically applies the one or more mitigation actions of the determined set of mitigation actions to proactively protect the service endpoint from potential cyberattacks. Non-limiting examples of mitigation actions include (i) increasing the degree of certainty that the user is who he/she says he/she is by prompting the user to answer one or more security questions and/or by enabling multi-factor authentication; (ii) temporarily denying access to the user to all protected service endpoints or the service endpoint at issue for a predetermined or configurable amount of time (e.g., 30 minutes); and (iii) completely denying access to the service endpoint at issue or all protected service endpoints (subject to reset by the system administrator). In this manner, the the security administrator may avoid frequent interruption by spurious alerts as mitigation of many types of anomalies can be handled in an automated fashion.

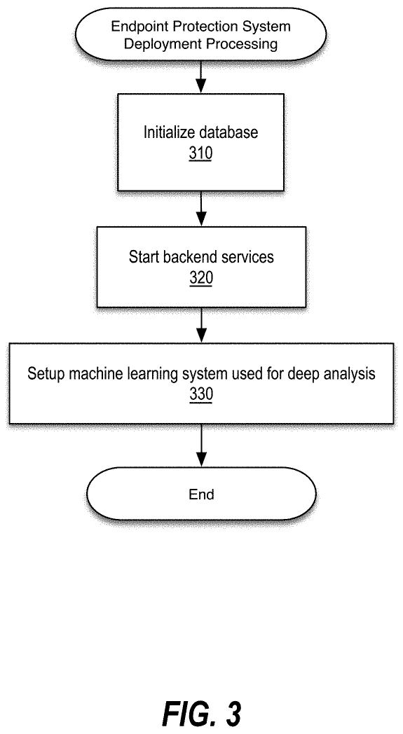

FIG. 3 is a flow diagram illustrating endpoint protection system deployment processing in accordance with an embodiment. At block 310, a database used by the endpoint protection system is initialized. According to one embodiment, the database includes database tables representing the service details datastore 111, the endpoint security protection policy datastore 121, the access details datastore 131 and the security alerts datastore 141.

At block 320, backend services are started. According to one embodiment, the backend services include one or more of the various components described with reference to FIG. 1.

At block 330, the machine learning system that is to be used for deep analysis is setup. For example, the system may be configured to use the desired artificial intelligence (AI) model.

FIG. 4 is a flow diagram illustrating user access pattern processing in accordance with an embodiment. At block 410, a notification is received by the endpoint protection system regarding a user access to a particular service endpoint. According to one embodiment, the notification is directed to the endpoint usage pattern observation engine 130 and includes metadata associated with the access.

At block 420, the location from which the service endpoint is being accessed may be inferred. According to one embodiment, service details regarding the service may be retrieved from the service details datastore 111. For example, the system may evaluate the following information: (i) the service endpoint that is being used; (ii) the user (e.g., based on authentication) that is using the service endpoint and the role (e.g., determined via role based access control (RBAC)) that is being used; and (iii) the location and device that are being used.

According to one embodiment, the IP address of the client device (or a proxy behind which the client device resides) may be used to derive the location from which the service endpoint is being accessed. For example, the endpoint usage pattern observation engine 130 or the endpoint usage pattern analyzer 134 may perform an IP geolocation lookup based on the IP address associated with the service endpoint access. In various embodiments, the IP address associated with the service endpoint access may be used even when the client device is behind a proxy or when the IP address is dynamically assigned by an Internet Service Provider (ISP) as it is the location pattern that is of interest not the precise location since identifying changes in behaviour (here the commonly used accessed location or IP address) is the objective. After the location information is inferred, it may be persisted, for example, to the access details datastore 131.

At block 430, device details regarding the client device being used to access the service endpoint are inferred. According to one embodiment, the User-Agent string associated with the service endpoint access may be used for this purpose. After device details are inferred, this information may be persisted, for example, to the access details datastore 131.

At block 440, information is collected about the workloads resulting from the service endpoint access. According to one embodiment a determination is made regarding what workload was subjected to the service endpoint. After this information is collected, it may be persisted, for example, to the access details datastore 131.

FIG. 5 is a flow diagram illustrating anomaly detection processing in accordance with an embodiment. At block 510, a request to analyze the endpoint access is received. In one embodiment, the request is originated by the endpoint usage pattern observation engine 130 and is issued to the endpoint usage pattern analyzer 134.

At block 515, information regarding the current service access pattern is retrieved. For example, the endpoint usage pattern analyzer 134 may retrieve this information from the access details datastore 131 that was previously persisted by the endpoint usage pattern analyzer 132. For example, the endpoint usage pattern analyzer 134 may retrieve the service details from the service details datastore 111.

At block 520, historical access datasets are retrieved. According to one embodiment, the historical access datasets retrieved are indicative of a historical access pattern. For example, historical data involving the service endpoint and the user may be retrieved from the access details 131.

At block 525, machine learning is applied to detect anomalies associated with the current service endpoint access. According to one embodiment, an intelligent deduction is made regarding whether the current service endpoint access represents an anomaly in relation to the normal access pattern by this user. Furthermore, when an anomaly is detected, deep learning may be used to determine the type of anomaly (e.g., a location anomaly, a device anomaly and/or a workload anomaly). In the context of the present example, the anomalous nature of the current service endpoint access is not limited to one factor. For example, the user may be accessing the service endpoint from a different location than considered normal, from a different device than considered normal and may be subjecting the service endpoint to a different workload than considered normal.

At decision block 530, it is determined whether the anomaly is a location anomaly representing an aberration in the pattern of locations from which the user has historically accessed the service endpoint. If so, then processing branches to block 535; otherwise, processing continues with decision block 540.

At block 535, location anomaly details are collected and prepared. For example, assume a particular user has historically used mobile and laptop devices to access a particular service endpoint from two locations (e.g., from home in Denver and from the office in Fort Collins) in Colorado and now, the system is observing that the same service endpoint is being accessed from a location (e.g., Beijing, China) that has never been used by the particular user to access this particular service endpoint. According to one embodiment, information regarding one or more of the historical location access pattern and the location anomaly may be recorded.

At decision block 530, it is determined whether the anomaly is a device anomaly representing an aberration in the pattern of devices the user has historically used to access the service endpoint. If so, then processing branches to block 545 at which information regarding the client device and aberration details are collected and prepared; otherwise, processing continues with decision block 540.

At decision block 540, it is determined whether the anomaly is a workload anomaly representing an aberration in the pattern of workloads the user has historically subjected to the service endpoint. If so, then processing branches to block 555 at which details are inferred regarding the client device being used by the user to access the service endpoint; otherwise, processing continues with block 560.

At block 560, the details collected and prepared regarding the detected anomaly are returned to the caller (e.g., the endpoint usage pattern observation engine 130).

FIG. 6 is a flow diagram illustrating anomaly mitigation processing in accordance with an embodiment. At block 610, a request to apply a set of mitigation actions for the detected anomaly is received. In one embodiment, the request is originated by the endpoint usage pattern observation engine 130 and is issued to the endpoint risk mitigation engine 140.

At block 620, the appropriate protection policy is retrieved. According to one embodiment, an endpoint protection policy defined by the security administrator for the detected anomaly is retrieved from the endpoint security protection policy datastore 121. In one embodiment, when the detected anomaly represents a new aberration pattern, for example, that is not associated with an endpoint protection policy previously defined by the security administrator, then a default protection policy may be retrieved.

At block 630, the anomaly is analyzed. According to one embodiment, machine learning may be applied to the anomaly to determine a level of severity associated with the anomaly.

At decision block 630, based on the level of severity and the retrieved endpoint protection policy (e.g., defining the set of mitigation actions to be applied for the various levels of severity), processing continues with one of blocks 650, 660, or 670. In the context of the present example, when the level of severity is low, processing continues with block 650, when the level of severity is medium, processing continues with block 660, and when the level of severity is high, processing continues with block 670.

At block 650, the standards that need to be met for user authentication may be raised. According to one embodiment, multi-factor authentication may be enabled. For example, prior to proceeding with the user request being made via the service endpoint access, the user may be prompted to answer one or more security questions and/or may be prompted to enter a code provided via short message service (SMS) or via an authentication application.

At block 660, the user's access to the service endpoint may be temporarily denied. According to one embodiment, the user may be denied access to the service endpoint or to all protected service endpoints for a predetermined or configurable amount of time (e.g., 30 minutes or until otherwise reset by the security administrator).

At block 670, the user's access to the service endpoint may be completely denied (subject to override or reset by the security administrator).

At block 680, the caller (e.g., the endpoint usage pattern observation engine 130) is alerted regarding the detected anomaly as well as the set of mitigation steps applied. According to one embodiment, this information may also be persisted, for example, to the security alerts datastore 141 via the endpoint risk engine 145, which may cause the security administrator to be notified as appropriate.

While in the context of the present example, it is assumed that the endpoint protection policy associated a first mitigation action (e.g., application of multi-factor authentication) to low severity anomalies, a second mitigation action (e.g., temporary denial of access) to medium severity anomalies, and a third mitigation action (e.g., denial of service endpoint access) to high severity anomalies, those skilled in the art will appreciate that different endpoint protection profiles may associate different sets of mitigation actions with low, medium and/or high severity anomalies.

Embodiments described herein include various steps, examples of which have been described above. As described further below, these steps may be performed by hardware components or may be embodied in machine-executable instructions, which may be used to cause a general-purpose or special-purpose processor programmed with the instructions to perform the steps. Alternatively, at least some steps may be performed by a combination of hardware, software, and/or firmware.

Embodiments described herein may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to example embodiments described herein with appropriate standard computer hardware to execute the code contained therein. An apparatus for practicing various example embodiments described herein may involve one or more computing elements or computers (or one or more processors within a single computer) and storage systems containing or having network access to computer program(s) coded in accordance with various methods described herein, and the method steps of various example embodiments described herein may be accomplished by modules, routines, subroutines, or subparts of a computer program product.

FIG. 7 is a block diagram of a computer system in accordance with an embodiment. In the example illustrated by FIG. 7, computer system 700 includes a processing resource 710 coupled to a non-transitory, machine readable medium 720 encoded with instructions to perform a proactive auto-scaling method in accordance with a private cloud embodiment. The processing resource 710 may include a microcontroller, a microprocessor, central processing unit core(s), an ASIC, an FPGA, and/or other hardware device suitable for retrieval and/or execution of instructions from the machine readable medium 720 to perform the functions related to various examples described herein. Additionally or alternatively, the processing resource 710 may include electronic circuitry for performing the functionality of the instructions described herein.

The machine readable medium 720 may be any medium suitable for storing executable instructions. Non-limiting examples of machine readable medium 720 include RAM, ROM, EEPROM, flash memory, a hard disk drive, an optical disc, or the like. The machine readable medium 720 may be disposed within the computer system 700, as shown in FIG. 7, in which case the executable instructions may be deemed “installed” or “embedded” on the computer system 700. Alternatively, the machine readable medium 720 may be a portable (e.g., external) storage medium, and may be part of an “installation package.” The instructions stored on the machine readable medium 720 may be useful for implementing at least part of the methods described herein.

In the context of the present example, the machine readable medium 720 is encoded with a set of executable instructions 730-760. It should be understood that part or all of the executable instructions and/or electronic circuits included within one block may, in alternate implementations, be included in a different block shown in the figures or in a different block not shown.

Instructions 730, upon execution, cause the processing resource 710 to train a machine-learning model to recognize anomalies in service endpoint access patterns. In one embodiment, instructions 730 may correspond generally to instructions for performing block 210 of FIG. 2.

Instructions 740, upon execution, cause the processing resource 710 to identify an anomaly relating to an access to a service endpoint. In one embodiment, instructions 740 may correspond generally to instructions for performing block 220 of FIG. 2.

Instructions 750, upon execution, cause the processing resource 710 to determine a mitigation action for an anomaly. In one embodiment, instructions 750 may correspond generally to instructions for performing block 230 of FIG. 2.

Instructions 760, upon execution, cause the processing resource 710 to apply a determined mitigation action. In one embodiment, instructions 756 may correspond generally to instructions for performing block 240 of FIG. 2.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

What is claimed is:

1. A computer-implemented method comprising:
training a machine-learning model to recognize anomalies in access patterns relating to a plurality of endpoints of a cloud-based service by capturing metadata associated with accesses by users to the plurality of endpoints, wherein the metadata for a given access of the accesses includes information regarding a particular user that initiated the given access, a particular device utilized by the particular user, a particular location of the particular device and specific workloads associated with the given access;
identifying an anomaly in relation to an access by a user to a service endpoint of the plurality of service endpoints by monitoring the access patterns and applying the machine-learning model to metadata associated with the access;
based on a degree of risk to the cloud-based service associated with the identified anomaly, determining a mitigation action of a plurality of predefined mitigation actions; and
proactively protecting the cloud-based service by programmatically applying the determined mitigation action.

2. The computer-implemented method of claim 1, further comprising receiving from a security administrator a policy defining permissible access to a service endpoint of the plurality of endpoints for the user.

3. The computer-implemented method of claim 2, wherein the policy excludes conditions relating to a type of device and conditions relating to location.

4. The computer-implemented method of claim 2, wherein said identifying an aberration in relation to an access by a user to a service endpoint of the plurality of service endpoints includes determining the policy has been violated based the metadata associated with the access.

5. The computer-implemented method of claim 1, further comprising training the machine-learning model to recognize a plurality of degrees of risk associated with the access patterns.

6. The computer-implemented method of claim 1, wherein the plurality of predefined mitigation actions include requiring the user to confirm their identity via multi-factor authentication, sending an alert to the security administrator, prohibiting access by the user to the cloud-based service for a predefined or configurable period of time, or prohibiting access by the user to the cloud-based service.

7. The computer-implemented method of claim 1, further comprising:
receiving from the security administrator a whitelist specifying an override access pattern for which none of the plurality of predefined mitigation actions are to be applied; and
wherein said identifying an aberration in relation to an access by a user to a service endpoint of the plurality of service endpoints excludes the override access pattern.

8. The computer-implemented method of claim 1, wherein the plurality of endpoints comprise Representational State Transfer (REST) Application Programming Interfaces (APIs).

9. A non-transitory machine readable medium storing instructions executable by a processing resource of a computer system, the non-transitory machine readable medium comprising instructions to:
train a machine-learning model to recognize anomalies in access patterns relating to a plurality of endpoints of a cloud-based service by capturing metadata associated with accesses by users to the plurality of endpoints, wherein the metadata for a given access of the accesses includes information regarding a particular user that initiated the given access, a particular device utilized by the particular user, a particular location of the particular device and specific workloads associated with the given access;
identify an anomaly in relation to an access by a user to a service endpoint of the plurality of service endpoints by monitoring the access patterns and applying the machine-learning model to metadata associated with the access;
based on a degree of risk to the cloud-based service associated with the identified anomaly, determine a mitigation action of a plurality of predefined mitigation actions; and
proactively protect the cloud-based service by programmatically applying the determined mitigation action.

10. The non-transitory machine readable medium of claim 9, further comprising instructions to receive from a security administrator a policy defining permissible access to a service endpoint of the plurality of endpoints for the user.

11. The non-transitory machine readable medium of claim 10, wherein the policy excludes conditions relating to a type of device and conditions relating to location.

12. The non-transitory machine readable medium of claim 10, wherein identification of the aberration includes determining the policy has been violated based on the metadata associated with the access.

13. The non-transitory machine readable medium of claim 9, further comprising instructions to train the machine-learning model to recognize a plurality of degrees of risk associated with the access patterns.

14. The non-transitory machine readable medium of claim 13, wherein the degree of risk is determined based on said applying the machine-learning model to metadata associated with the access.

15. The non-transitory machine readable medium of claim 9, wherein the plurality of predefined mitigation actions include requiring the user to confirm their identity via multi-factor authentication, sending an alert to the security administrator, prohibiting access by the user to the cloud-based service for a predefined or configurable period of time, or prohibiting access by the user to the cloud-based service.

16. The non-transitory machine readable medium of claim 9, further comprising instructions to:
receive from the security administrator a whitelist specifying an override access pattern for which none of the plurality of predefined mitigation actions are to be applied; and
wherein identification of the aberration excludes the override access pattern.

17. The non-transitory machine readable medium of claim 9, further comprising instructions to generate a report for a specified period of time containing information associated with each identified aberration during the specified period of time.

18. The non-transitory machine readable medium of claim 9, wherein the plurality of endpoints comprise Representational State Transfer (REST) Application Programming Interfaces (APIs).

19. A system comprising:
a processing resource; and
a non-transitory computer-readable medium, coupled to the processing resource, having stored therein instructions that when executed by the processing resource cause the processing resource to:
train a machine-learning model to recognize anomalies in access patterns relating to a plurality of endpoints of a cloud-based service by capturing metadata associated with accesses by users to the plurality of endpoints, wherein the metadata for a given access of the accesses includes information regarding a particular user that initiated the given access, a particular device utilized by the particular user, a particular location of the particular device and specific workloads associated with the given access;
identify an anomaly in relation to an access by a user to a service endpoint of the plurality of service endpoints by monitoring the access patterns and applying the machine-learning model to metadata associated with the access;
based on a degree of risk to the cloud-based service associated with the identified anomaly, determine a mitigation action of a plurality of predefined mitigation actions; and
proactively protect the cloud-based service by programmatically applying the determined mitigation action.

20. The system of claim 19, wherein the plurality of predefined mitigation actions include requiring the user to confirm their identity via multi-factor authentication, sending an alert to the security administrator, prohibiting access by the user to the cloud-based service for a predefined or configurable period of time, or prohibiting access by the user to the cloud-based service.
